(19) United States
(12) Patent Application Publication
(10) Pub. No.: US 2026/0347675 A1
(43) Pub. Date: Nov. 5, 2026

(54) CURABLE RESIN COMPOSITION AND LAMINATE BODY

(71) Applicants: Kaneka Americas Holding, Inc., Pasadena, TX (US); KANEKA CORPORATION, Osaka (JP)

(72) Inventors: Shota Koya, Pasadena, TX (US); Hideharu Jyono, Hyogo (JP)

(73) Assignees: Kaneka Americas Holding, Inc., Pasadena, TX (US); KANEKA CORPORATION, Osaka (JP)

(21) Appl. No.: 19/658,238

(22) Filed: Apr. 24, 2026

Related U.S. Application Data
(60) Provisional application No. 63/795,022, filed on Apr. 25, 2025.

(51) Int. Cl. C09J 183/12; C08G 77/46; C09J 5/00; C09J 11/06

(52) U.S. Cl. CPC C09J 183/12; C08G 77/46; C09J 5/00; C09J 11/06; C09J 2203/346; C09J 2483/00

(57) ABSTRACT

A curable resin composition including 100 parts by weight of a moisture curable resin containing a reactive silyl group, 2 to 100 parts by weight of a thixotropic agent and 5 to 20 parts by weight of an adhesion promoter, is provided. A Brookfield viscosity of the curable resin composition is 10,000 cP or more and 1,000,000 cP or less at a temperature of 23 °C at 10 rpm. A laminate body including a tile, a backer board and a cured resin composition of the curable resin composition disposed between the backer board and the tile, is also provided. A method including cutting the laminate body to predetermined size, thereby forming a cut body, applying an adhesive to a surface of the cut body on a backer board side and bonding the cut body to a substrate, is also provided.

### BACKGROUND

Two-component curable resin compositions such as epoxy compositions are often used for bonding a tile on a backer board to produce a laminate body bonded to a substrate. Such two-component compositions are required to mix a resin with a curing agent just before being applied with proper ratio. In contrast, one-component curable resin compositions do not require mixing just before they are applied. However, one-component curable resin compositions generally have relatively high elasticity, and therefore the cut surfaces of the laminate bodies are frequently uneven when the laminate bodies are cut into predetermined size to be applied to the substrate. Accordingly, there exists a need for continuing improvement of curable resin compositions such as tile-backer board adhesives.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a curable resin composition including 100 parts by weight of a moisture curable resin containing a reactive silyl group, 2 to 100 parts by weight of a thixotropic agent and 5 to 20 parts by weight of an adhesion promoter. A Brookfield viscosity of the curable resin composition is 10,000 cP or more and 1,000,000 cP or less at a temperature of 23 °C at 10 rpm.

In another aspect, embodiments disclosed herein relate to a laminate body including a tile, a backer board and a cured resin composition of the previously described curable resin composition disposed between the backer board and the tile.

In yet another aspect, embodiments disclosed herein relate to a method including cutting the previously described laminate body to predetermined size, thereby forming a cut body, applying an adhesive to a surface of the cut body on a backer board side and bonding the cut body to a substrate.

Other aspects and advantages of the claimed subject matter will be apparent from the following description and the appended claims.

### BRIEF DESCRIPTION OF DRAWINGS

FIG. 1A is an example showing the cut surface satisfying a backer board crack conformity test.

FIG. 1B is an example showing the cut surface not satisfying the backer board crack conformity test.

FIG. 2A is an example showing a curable resin composition satisfying a shape retention test.

FIG. 2B is an example showing a curable resin composition not satisfying the shape retention test.

### DETAILED DESCRIPTION

The present disclosure generally relates to a curable resin composition, a laminate body and a method including cutting the laminate body to form a cut body and applying the cut body to a substrate. The curable resin composition includes a moisture curable resin containing a reactive silyl group, a thixotropic agent and an adhesion promoter. The laminate body includes a tile, a backer board and a cured resin composition of the curable resin composition.

### Moisture Curable Resin

As noted above, the present disclosure generally relates to a curable resin composition that includes a moisture curable resin containing a reactive silyl group, a thixotropic agent and an adhesion promoter. In accordance with one or more embodiments, the moisture curable resin is a polymer containing functional group(s) such as reactive silyl groups that are reactive with moisture or water. The moisture curable resin is not particularly limited, and may include a polyoxyalkylene-based polymer containing a reactive silyl group, a (meth)acrylic ester-based copolymer containing a reactive silyl group or combinations thereof. Suitable moisture curable resin may be the polyoxyalkylene-based polymer containing the reactive silyl group.

The polyoxyalkylene-based polymer containing the reactive silyl group includes a polyoxyalkylene polymer chain. The polyoxyalkylene-based polymer containing the reactive silyl group may be crosslinked by siloxane condensation reaction of the reactive silyl group. The polyoxyalkylene polymer chain may include a urethane bond or a urea bond.

The polyoxyalkylene-based polymer containing the reactive silyl group may have linear or branched structures, and the number-average molecular weight (Mn) may be in a range of from about 500 to about 100,000, such as a lower limit selected from any one of 500, 1000, 2000, and 3000 to an upper limit selected from any one of 10,000, 15,000, 50,000, and 100,000 where any lower limit may be paired with any upper limit. The Mn is measured with the use of HLC-8120GPC (TOSOH CORPORATION) as a solution-sending system, TSK-GEL H type column (TOSOH CORPORATION), and THF solvent.

The polyoxyalkylene-based polymer containing the reactive silyl group may have a molecular weight distribution (Mn/Mw), or a ratio of Mn and weight-average molecular weight (Mw), of 1.6 or less, such as 1.6 or less, 1.4 or less, or 1.2 or less.

Examples of the polyoxyalkylene-based polymer containing the reactive silyl group may include, but are not limited to, KANEKA MS POLYMER S810, S257, S327, S203H and S303H, KANEKA SILYL SAT010, SAX015, SAX140, SAX220, SAX260, SAX350, SAX400, SAX510, SAX520, SAX580, SAX590 and SAX750, Excestar ES-S2410, ES-S2420 and ES-S3630, GENIOSIL STP-E10, STP-E15, STP-E-30 and STP-E-35, and combinations thereof.

A specific structure of the reactive silyl groups is not specifically limited, but may include reactive silyl groups represented by the general formula (1):

—Si(R¹₃₋ₐ)Xₐ (1)

where R¹ represents an alkyl group having 1 to 20 carbon atoms, an aryl group having 6 to 20 carbon atoms, or an aralkyl group having 7 to 20 carbon atoms; X represents a hydrolyzable group, wherein each X is the same or different when two or more X are present; a is an integer from 1 to 3, wherein, when a is 1, each R¹ may be the same or different, and when a is 2 or 3, each X may be the same or different.

Examples of the reactive silyl group include trimethoxysilyl groups, triethoxysilyl groups, triisopropoxysilyl groups, dimethoxymethylsilyl groups, diethoxymethylsilyl groups, diisopropoxymethylsilyl groups, (chloromethyl)dimethoxysilyl groups, (methoxymethyl)dimethoxysilyl groups, and combinations thereof.

The reactive silyl group of the polyoxyalkylene-based polymer containing the reactive silyl group may be bonded to a terminal end of the polymer chain or along the polymer chain between the terminal ends, or a plurality of the reactive silyl groups may be bonded to both the terminal ends and along the polymer chain.

The number of the reactive silyl groups in a single polymer chain of the polyoxyalkylene-based polymer containing the reactive silyl group may be 0.5 or more on average, or 1 or more on average; or they may be in a range of from about 0.5 to 6, such as in a range of from a lower limit selected from any one of 0.5, 0.6, 0.7, 0.8, 0.9, 1.0, 1.1, 1.5 and 2.0 to an upper limit selected from any one of 3.0, 4.0, 5.0 and 6.0, where any lower limit may be paired with any upper limit.

A polyoxyalkylene structure in the polyoxyalkylene-based polymer containing the reactive silyl group may be a linear or branched structure. The polyoxyalkylene-based polymer may derive from polyoxypropylene diol or polyoxypropylene triol.

The polyoxyalkylene structure may include one or more types of repeating units. The polyoxyalkylene structure may include one type of the polyoxyalkylene structure, or two or more types of polyoxyalkylene structures.

Examples of the polyoxyalkylene polymer chain include a structure which has a repeating unit represented by the general formula (2). In the formula, R² is a bivalent alkylene group.

—R²—O— (2)

The structure represented by the general formula (2) may include not less than 50% by weight, not less than 70% by weight or not less than 90% by weight of the total weight of the polyoxyalkylene-based polymer containing the reactive silyl group.

A specific structure of R² in the general formula (2) is not particularly limited, and may be an alkylene group having 1 to 14 carbon atoms or a linear or branched alkylene group having 2 to 4 carbon atoms. Specific examples of the repeating unit represented by the general formula (2) may be —CH₂O—, —CH₂CH₂O—, —CH₂CH(CH₃)O—, —CH₂CH(C2H5)O—, —CH₂C(CH₃)₂O—, or —CH₂CH₂CH₂CH₂O—. When the polyoxyalkylene polymer chain includes-CH₂CH(CH₃)O— in the repeating unit, the glass transition temperature (Tg) of the polyoxyalkylene-based polymer containing the reactive silyl group may be easily adjusted to not higher than 0 °C.

In accordance with one or more embodiments, the (meth)acrylic ester-based copolymer containing the reactive silyl group includes a (meth)acrylic ester polymer chain. The (meth)acrylic ester-based copolymer containing the reactive silyl group may be crosslinked by siloxane condensation reaction of the reactive silyl group.

The number-average molecular weight (Mn) of the (meth)acrylic ester-based copolymer containing the reactive silyl group may be in a range of from about 500 to about 100,000, such as a lower limit selected from any one of 500, 1,000, 2,000, and 3,000 to an upper limit selected from any one of 10,000, 15,000, 50,000, and 100,000 where any lower limit may be paired with any upper limit. The Mn is measured with the use of HLC-8120GPC (TOSOH CORPORATION) as a solution-sending system, TSK-GEL H type column (TOSOH CORPORATION), and THE solvent.

The (meth)acrylic ester-based copolymer containing the reactive silyl group may have a molecular weight distribution (Mn/Mw), or a ratio of Mn and weight-average molecular weight (Mw), of 1.6 or less, such as 1.6 or less, 1.4 or less, or 1.2 or less.

Specific examples of the (meth)acrylic ester-based copolymer containing the reactive silyl group may include, but are not limited to, one or more of KANEKA XMAP SA100S, SA110S, SA120S, SA310S and SA410S, ARUFON US-6100, US-6110, US-6120, US-6130, US-6140, US-6150, US-6170, US-6180 and US-6190, and ACTFLOW NE-1000.

A specific structure of the reactive silyl groups is not specifically limited, but may include reactive silyl groups represented by the general formula (1) described above.

Examples of the reactive silyl group include trimethoxysilyl groups, triethoxysilyl groups, triisopropoxysilyl groups, dimethoxymethylsilyl groups, diethoxymethylsilyl groups, diisopropoxymethylsilyl groups, (chloromethyl)dimethoxysilyl groups, (methoxymethyl)dimethoxysilyl groups, and combinations thereof.

The reactive silyl group of the (meth)acrylic ester-based copolymer containing the reactive silyl group may be bonded to a terminal end of the polymer chain or along the polymer chain between the terminal ends, or a plurality of the reactive silyl groups may be bonded to both the terminal ends and along the polymer chain.

The number of the reactive silyl groups in a single polymer chain of the (meth)acrylic ester-based copolymer containing the reactive silyl group may be 0.5 or more on average, or 1 or more on average; or they may be in a range of from about 0.5 to 6, such as in a range of from a lower limit selected from any one of 0.5, 0.6, 0.7, 0.8, 0.9, 1.0, 1.1, 1.5 and 2.0 to an upper limit selected from any one of 3.0, 4.0, 5.0 and 6.0, where any lower limit may be paired with any upper limit.

A (meth)acrylic ester structure in the (meth)acrylic ester-based copolymer containing the reactive silyl group may be a linear or branched structure. The (meth)acrylic ester structure may include one or more types of repeating units. The (meth)acrylic ester structure may include one type of the (meth)acrylic ester structure, or two or more types of the (meth)acrylic ester structures.

Examples of the (meth)acrylic ester polymer chain include a structure which has a repeating unit represented by the general formula (3). In the formula, R³ is a hydrogen atom or a methyl group, and R⁴ is a group having one or more carbon atoms. The number of the carbon atoms in R⁴ may be, for example, 1 to 22. R⁴ may be an alkyl group, a cycloalkyl group, or an aryl group. R⁴ may be substituted with a halogen, a hydroxy group, an alkoxy group, or an amino group.

—CH(R³)—CH(COOR⁴)— (3)

The structure represented by the general formula (3) may be obtained by polymerization of a (meth)acrylic monomer. Examples of the (meth)acrylic monomer include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, octyl (meth)acrylate, 2-methoxyethyl (meth)acrylate, 3-methoxybutyl (meth)acrylate, 2-ethoxyethyl (meth)acrylate, 2-butoxyethyl (meth)acrylate, isopropoxyethyl (meth)acrylate, phenyl (meth)acrylate, tolyl (meth)acrylate, benzyl (meth)acrylate, 2-hydroxyethyl (meth)acrylate, 2-hydroxypropyl (meth)acrylate, 2,2,2-trifluoroethyl (meth)acrylate, glycidyl (meth)acrylate, 1-ethylcyclopentylether (meth)acrylate, dimethylaminoethyl (meth) acrylate, nonyl (meth)acrylate, decyl (meth)acrylate, undecyl (meth)acrylate, dodecyl (meth)acrylate, tridecyl (meth)acrylate, tetradecyl (meth)acrylate, pentadecyl (meth) acrylate, hexadecyl (meth)acrylate, heptadecyl (meth)acrylate, stearyl (meth) acrylate, icosyl (meth)acrylate, docosyl (meth)acrylate, lauryl (meth)acrylate, stearyl (meth)acrylate, oleyl (meth)acrylate, linoleyl (meth)acrylate, isobornyl (meth) acrylate, 2-aminoethyl (meth)acrylate, Y-(methacryloyloxypropyl)trimethoxysilane, an ethylene oxide adduct of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutyl ethyl (meth) acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth) acrylate, 2-perfluorohexylethyl (meth)acrylate, 2-perfluorodecylethyl (meth) acrylate, 2-perfluorohexadecylethyl (meth)acrylate and combinations thereof.

Suitable (meth)acrylic monomer(s) may include, but are not limited to, ethyl acrylate, n-propyl acrylate, n-butyl acrylate, 2-ethylhexyl acrylate, 2-ethylhexyl methacrylate, stearyl acrylate, and combinations thereof. When the (meth)acrylic ester polymer chain derives from any of these monomers, the glass transition temperature (Tg) of the (meth)acrylic ester-based copolymer containing the reactive silyl group may be easily adjusted to not higher than 0 °C.

When the moisture curable resin includes the polyoxyalkylene-based polymer containing the reactive silyl group and the (meth)acrylic ester-based copolymer containing the reactive silyl group, the weight ratio of the polyoxyalkylene-based polymer containing the reactive silyl group and the (meth)acrylic ester-based copolymer containing the reactive silyl group may be about between 5:95 and 50:50 to exhibit high plasticity and high shear adhesion strength or may be about between 99:1 and 50:50 or between 99:1 and 70:30 to exhibit high plasticity and high rigidity.

### Adhesion Promoter

In one or more embodiments, the curable resin composition includes at least one adhesion promoter. Examples of adhesion promoters may include, but are not limited to, silane coupling agents; reaction products of silane coupling agents, such as isocyanate-group-containing silanes, amino-group-containing silanes (aminosilane) (e.g., DAMO-T is available from Evonik), mercapto-group-containing silanes, epoxy-group-containing silanes, vinylically unsaturated group containing silanes, and halogen-containing silanes; amino-modified-silyl polymers; unsaturated aminosilane complexes; phenylamino long chain alkyl-silanes; aminosilylated silicones; silylated polyesters and combinations thereof.

In one or more embodiments, the amount of the adhesion promoter in the curable resin composition is in a range of from about 1 part by weight to about 40 parts by weight with respect to 100 parts by weight of the moisture curable resin containing the reactive silyl group, such as a lower limit selected from any one of 1, 3, 5, 7, 10, 15 and 20 parts, to an upper limit selected from any one of 10, 20, 30 and 40 parts, where any lower limit may be paired with any mathematically compatible upper limit.

### Thixotropic Agents

In one or more embodiments, the curable resin composition includes at least one thixotropic agent. Examples of thixotropic agents may include, but are not limited to, a hydrogenated castor oil (e.g., Crayvallac available from Arkema), an organic amid wax, an organic bentonite, a calcium stearate, a surface-treated calcium carbonate (e.g., Viscoexcel-30 available from Shiraishi, Hakuenka CC-R available from Shiraishi), a fumed silica (e.g., Aerosil available from Evonik) and combinations thereof.

In one or more embodiments, the amount of the thixotropic agent in the curable resin composition is in a range of from about 1 part by weight to about 100 parts by weight with respect to 100 parts by weight of the moisture curable resin containing the reactive silyl group, such as a lower limit selected from any one of 1, 2, 5, 7, 10, 15, 20 and 25 parts, to an upper limit selected from any one of 15, 20, 25, 30, 40, 50, 60, 70, 80, 90, 100 parts, where any lower limit may be paired with any mathematically compatible upper limit.

### Plasticizer

In one or more embodiments, the curable resin composition includes at least one plasticizer. Examples of plasticizers may include, but are not limited to, benzoate, phthalates, cyclohexyl diesters, glycol diester, petroleum distillate, process oil, polypropylene glycol and combinations thereof. Benzoate plasticizers may include isodecyl benzoate (e.g., Jayflex™ MB10 (“MB10”) available from ExxonMobil). Glycol diester plasticizers may include tri (ethylene glycol)bis(2-ethylhexanoate) “TEG-EH” (e.g. Oxfilm 351 available from OQ Chemicals). Phthalates plasticizers may include diisononyl phthalates (e.g., DPHP available from BASF and Jayflex™ DINP available from Exxon Mobil). Cyclohexyl diesters plasticizers may include 1,2-cyclohexane dicarboxylic acid diisononyl ester (e.g. Hexamoll™ DINCH available from BASF). Petroleum distillate plasticizers may include Fluid D 170 LPP (available from TotalEnergies). Polypropylene glycol plasticizers may include PPG3000 (available from Mitsui Chemicals, Inc.). Process oil plasticizers may include paraffinic process oils, naphthenic process oils (e.g., Exxol D80 available from ExxonMobil), and aromatic process oils.

In one or more embodiments, the amount of the plasticizer in the curable resin composition is in a range of from about 10 parts by weight to about 200 parts by weight with respect to 100 parts by weight of the moisture curable resin containing the reactive silyl group, such as a lower limit selected from any one of 10, 20, 30 and 50 parts, to an upper limit selected from any one of 100, 150, 180 and 200 parts, where any lower limit may be paired with any upper limit.

### Silica Sand

In one or more embodiments, the curable resin composition includes a silica sand which is naturally occurring material composed of high levels of silicon dioxide. The average particle diameter of the silica sand may range from 10 μm to 800 μm, such as a lower limit selected from any one of 10, 20, 30, 40, 60 and 90 μm, to an upper limit selected from any one of 100, 200, 400, 450 and 800 μm, where any lower limit may be paired with any upper limit.

In one or more embodiments, the amount of the silica sand in the curable resin composition is in a range of from about 1 part by weight to about 200 parts by weight with respect to 100 parts by weight of the moisture curable resin containing the reactive silyl group, such as a lower limit selected from any one of 1, 10, 20, 30 and 40 parts, to an upper limit selected from any one of 80, 100, 150 and 200 parts, where any lower limit may be paired with any upper limit.

### Filler

In one or more embodiments, the curable resin composition includes a filler. Examples of the fillers may include, but are not limited to, ground and precipitated calcium carbonate (CaCO₃), magnesium carbonate, diatomite, calcined clay, clay, talc bentonite, reinforcing fillers such as precipitated silica, crystalline silica, and fibrous fillers such as glass fibers, filaments and combinations thereof. Specific examples of the CaCO₃ filler may include Hubercarb Q3T, Hubercarb G2T, and Hubercarb G8 (available from Huber Engineered Materials).

In one or more embodiments, the amount of the filler in the curable resin composition is in a range of from about 1 part by weight to about 800 parts by weight with respect to 100 parts by weight of the moisture curable resin containing the reactive silyl group, such as a lower limit selected from any one of 1, 50, 100, 150, 200, 300 and 400 parts, to an upper limit selected from any one of 550, 600, 700 and 800 parts, where any lower limit may be paired with any upper limit.

To reduce the weight of the curable resin composition, organic balloon fillers or inorganic balloon fillers may be used. As used herein, balloon fillers are roughly spherical fillers which are hollow inside. Specific examples of the balloon fillers may include EMC-80 (B) (available from Japan Fillite) and K₂O, S32HS (available from 3M).

In one or more embodiments, the amount of the balloon fillers in the curable resin composition is in a range of from about 1 part by weight to about 50 parts by weight with respect to 100 parts by weight of the moisture curable resin containing the reactive silyl group, such as a lower limit selected from any one of 1, 5 and 10 parts, to an upper limit selected from any one of 20, 30, 40 and 50 parts, where any lower limit may be paired with any upper limit.

### Catalytic Component

In one or more embodiments, the curable resin composition includes a catalytic component. Examples of the catalytic component include, but are not limited to, amine compounds such as aliphatic primary amines, aliphatic secondary amines, aliphatic tertiary amines, and aliphatic unsaturated amines; nitrogen-containing heterocyclic compounds such as pyridine and imidazole; amidines such as 1,8-diazabicyclo(5,4,0) undecane—7 (DBU); silanol condensation catalysts including titanium complexes such as organotins tetrabutyl titanate, tetrapropyl titanate, and titanium tetraacetryl acetonate, tetravalent tin compounds such as dibutyltin dilaurate, dibutyltin maleate, dibutyltin phthalate, dibutyltin dioctoate, dibutyltin diethylhexanoate, dibutyltin dimethylmaleate, dibutyltin diethylmaleate, dibutyltin dibutylmaleate, dibutyltin dioctylmaleate, dibutyltin ditridecylmaleate, dibutyltin dibenzylmaleate, dibutyltin diacetate, dioctyltin diethyl maleate, dioctyltin dioctylmaleate, dibutyltin dimethoxide, dibutyltin dinonylphenoxide, dibutenyltin oxide, dibutyltin diacetylacetonate, dibutyltin diethylacetoacetonate, and reaction products of dibutyltin oxide and phthalic esters; divalent tin compounds such as tin octylate, tin naphthenate, tin stearate, and tin versatate; inorganic tins; aluminum complexes such as aluminum trisacetyl acetonate, aluminum trisethyl acetoacetate, and diisopropoxyaluminum ethylacetoacetate, and combinations thereof.

Non-tin catalysts, including non-tin complexes, such as zinc complexes, may also be used as catalyst. A “non-tin” catalyst refers to a catalyst which contains no tin or no compounds containing tin, such as organotin compounds. Non-tin complexes that may be used as curable catalytic components include, but are not limited to, carboxylic acid metal salt catalysts, zinc complexes, titanium complexes and their condensates, amidine structure-containing complexes and combinations thereof. The non-tin complex may also include complexes generated in situ from any of the above combinations. Suitable non-tin catalysts may include, but are not limited to, a carboxylic acid metal salt catalyst, such as potassium neodecanoate (e.g., “TIB KAT K25” available from TIB Chemicals AG), a zinc complex (e.g. “K-KAT 670” available from King Industries), a titanium complex, such as diisopropoxy-bisethylacetoacetatotitanate (e.g., “Tyzor PITA” available from Dorf Ketal Chemical, LLC.), and combinations thereof.

Examples of other catalytic component may include, but are not limited to, phenol and epoxy resins, sulfur, alkyl titanates, and aromatic polyisocyanates, used alone or in combination.

In one or more embodiments, the amount of the catalytic component in the curable resin composition is in a range of from about 0.001 parts by weight to about 20 parts by weight with respect to 100 parts by weight of the moisture curable resin containing the reactive silyl group, such as a lower limit selected from any one of 0.001, 0.01, 0.05, 0.1 and 1 parts, to an upper limit selected from any one of 5, 10, 15 and 20 parts, where any lower limit may be paired with any upper limit.

### Dehydration Agent

In one or more embodiments, the curable resin composition includes a dehydration agent. Examples of the dehydration agent include, but are not limited to, alkoxysilane compounds such as n-propyl trimethoxysilane, vinyl trimethoxysilane (VTMO), vinyl methyldimethoxylsilane, γ-mercaptopropyl methyldimethoxysilane, γ-mercaptopropyl methyldiethoxysilane, γ-glycidoxypropyl trimethoxysilane, and octyl trimethoxy silane, and combinations thereof.

In one or more embodiments, the amount of the dehydration agent in the curable resin composition is in a range of from about 0.1 parts by weight to about 20 parts by weight with respect to 100 parts by weight of the moisture curable resin containing the reactive silyl group, such as a lower limit selected from any one of 0.1, 0.5 and 1 parts, to an upper limit selected from any one of 5, 10, 15 and 20 parts, where any lower limit may be paired with any upper limit.

### Additives

In one or more embodiments, the curable resin composition includes additives. The curable resin composition may include any suitable additives, such as pigments, UV inhibitors/absorbers, stabilizers, antioxidants, flame retardants, curability modifiers, lubricants, antifungal agents, and combinations thereof.

Examples of pigments may include, but are not limited to, titanium dioxide (TiO₂), carbon black and combinations thereof.

Examples of UV inhibitors/absorbers may include, but are not limited to, benzophenone compounds, benzotriazole compounds, triazine compounds, salicylate compounds, substituted tolyl compounds, metal chelate compounds and combinations thereof.

Examples of stabilizers may include, but are not limited to, hindered amine light stabilizer (HALS), benzotriazole compounds, benzoate compounds and combinations thereof.

Examples of antioxidants may include, but are not limited to, hindered phenolic antioxidants such as Irganox 245, 1010, and 1076 (available from BASF).

In one or more embodiments, the amount of the pigment in the curable resin composition is in a range of from about 0.1 parts by weight to about 20 parts by weight with respect to 100 parts by weight of the moisture curable resin containing the reactive silyl group, such as a lower limit selected from any one of 0.1, 1, 2 and 5 parts, to an upper limit selected from any one of 13, 15 and 20 parts, where any lower limit may be paired with any upper limit.

In one or more embodiments, the amount of the UV inhibitors/absorbers in the curable resin composition is in a range of from about 0.1 parts by weight to about 10 parts by weight with respect to 100 parts by weight of the moisture curable resin containing the reactive silyl group, such as a lower limit selected from any one of 0.1, 0.4 and 0.6 parts, to an upper limit selected from any one of 5, 8 and 10 parts, where any lower limit may be paired with any upper limit.

In one or more embodiments, the amount of the stabilizers in the curable resin composition is in a range of from about 0.1 parts by weight to about 10 parts by weight with respect to 100 parts by weight of the moisture curable resin containing the reactive silyl group, such as a lower limit selected from any one of 0.1, 0.4 and 0.6 parts, to an upper limit selected from any one of 5, 8 and 10 parts, where any lower limit may be paired with any upper limit.

In one or more embodiments, the amount of the antioxidants in the curable resin composition is in a range of from about 0.1 parts by weight to about 10 parts by weight with respect to 100 parts by weight of the moisture curable resin containing the reactive silyl group, such as a lower limit selected from any one of 0.1, 0.4 and 0.6 parts, to an upper limit selected from any one of 5, 8 and 10 parts, where any lower limit may be paired with any upper limit.

### Properties—Curable Resin Composition

The curable resin composition described herein may have suitable properties for various applications. For example, the composition may have a suitable viscosity for applying to various surfaces via spraying, roller-applied coating, or extrusion through a caulking gun.

In one or more embodiments, the curable resin composition has a viscosity of 25,000 cP or more and 5,000,000 cP or less at 1 rpm, as measured by a rotational viscometer, such as a lower limit selected from any one of 25,000, 40,000, 50,000, 100,000, 150,000 and 210,000 cP at 1 rpm, to an upper limit selected from any one of 1,000,000, 2,000,000, 3,000,000 and 5,000,000 cP at 1 rpm, where any lower limit may be paired with any upper limit. The viscosity of the curable resin composition described herein is measured by a rotational viscometer (Brookfield HA/HB/RV viscometer) at a temperature of 23 °C with HA/HB/RV-07/06 spindle.

In one or more embodiments, the curable resin composition has a viscosity of 18,000 cP or more and 3,000,000 cP or less at 2 rpm, as measured by a rotational viscometer, such as a lower limit selected from any one of 18,000, 30,000, 50,000, 60,000, 70,000, 130,000 cP at 2 rpm, to an upper limit selected from any one of 700,000, 800,000, 1,000,000 and 3,000,000 cP at 2 rpm, where any lower limit may be paired with any upper limit. The viscosity of the curable resin composition described herein is measured by a rotational viscometer (Brookfield HA/HB/RV viscometer) at a temperature of 23 °C with HA/HB/RV-07/06 spindle.

In one or more embodiments, the curable resin composition has a viscosity of 10,000 cP or more and 1,000,000 cP or less at 10 rpm, as measured by a rotational viscometer, such as a lower limit selected from any one of 10,000, 15,000, 24,000, 30,000, 55,000 and 70,000 cP at 10 rpm, to an upper limit selected from any one of 300,000, 500,000, 800,000 and 1,000,000 cP at 10 rpm, where any lower limit may be paired with any upper limit. The viscosity of the curable resin composition described herein is measured by a rotational viscometer (Brookfield HA/HB/RV viscometer) at a temperature of 23 °C with HA/HB/RV-07/06 spindle.

In one or more embodiments, the cured resin composition of the curable resin composition has a tensile strength at break of at least 1.1 MPa when tested according to ASTM D412. In one or more embodiments, the cured resin composition has a tensile strength at break in a range of from about 1.1 to about 5 MPa, such as in a range of from a lower limit selected from any one of 1.1, 1.3, 1.5, 1.7, 2.0, and 2.1 MPa, to an upper limit selected from any one of 2.2, 2.9, 3.0, 3.5, 4.0, 4.5 and 5.0 MPa.

### Method of Producing a Curable Resin Composition

In another aspect, embodiments disclosed herein relate to a method for producing a curable resin composition. The method may include mixing about 100 parts by weight of a moisture curable resin containing a reactive silyl group, 2 to 100 parts by weight of a thixotropic agent and 5 to 20 parts by weight of an adhesion promoter. The mixing may be conducted at a batch temperature in a range of from about 30 °C to 120 °C, and at a relative humidity of about 10% to 85%.

The present curable resin composition may be prepared as a one-component curable resin composition in which all components are blended in advance, it can be stored in a sealed state, and can then be cured by moisture in the air after being applied to a surface. In particular embodiments, when all components are blended in advance, each component containing moisture may be dried prior to use. The one-component curable resin composition may be dehydrated under reduced pressure during blending and kneading and/or may be dehydrated with the dehydration agent.

In one or more embodiments, the curable resin composition is prepared as a two-component curable resin composition. For example, components other than the moisture curable resin (such as a catalytic component, a filler, a plasticizer, and water) may be blended to produce a curing agent, and then the curing agent and the moisture curable resin are mixed just before being applied.

### Cured Resin Composition

Once the curable resin composition described above is cured, it may possess necessary mechanical properties such as hardness and tensile strength. The composition is considered as cured when upon handling with force, no material transfer occurs, and the material develops the majority of targeted mechanical properties such as tensile/elongation strength, hardness. Additionally, once applied to a surface and cured, the cured composition may exhibit good adhesion to the surface. The curable resin composition described above may be cured by being exposed to moisture in the ambient environment to produce the cured resin composition. As such, the resins described herein may be cured under ambient conditions, for example.

### Application

The curable composition may be used for various applications including adhesives, sealing materials, and coating materials. A suitable application for the curable composition may be a tile adhesive or a tile-backer board adhesive. The adhesives may be one-component adhesives including the one-component curable resin composition.

### Laminate Body

In another aspect, embodiments disclosed herein relate to a laminate body including a tile, a backer board and a cured resin composition of the curable resin composition. The cured resin composition is disposed between the backer board and the tile. The backer board is not particularly limited, but may be a gypsum board, a foam board such as a polyethylene terephthalate (PET) foam board and a polystyrene foam board and an asphalt board. Suitable laminate body may include the tile, the foam board and the cured resin composition.

In one or more embodiments, the laminate body is bonded to a substrate with an adhesive. The adhesive may include a curable resin composition described above. Examples of the substrate are mortar, concrete, ceramics, wooden substrates, waterproof sheets, organic membrane and other types of building sheathing board. The laminate body may be applied to a substrate once the laminate body is cut to predetermined size.

In accordance with one or more embodiments, the laminate body is cut to predetermined size thereby forming a cut body, the adhesive is applied to the cut body on a backer board side, then the cut body is bonded to the substrate. A tile cutter may be used to cut the laminate body or make a cut on the surface of the tile or the backer board. A suitable cut body has a substantially flat cut surface. In other words, a substantially flat cut surface means a cut surface of the backer board in the cut body is substantially in line with a cut surface of the tile in the cut body. While conventional laminate bodies include an adhesive having relatively high elasticity, they typically have non-flat cut surfaces. In contrast, a laminate body including the present cured resin composition has a substantially flat cut surface.

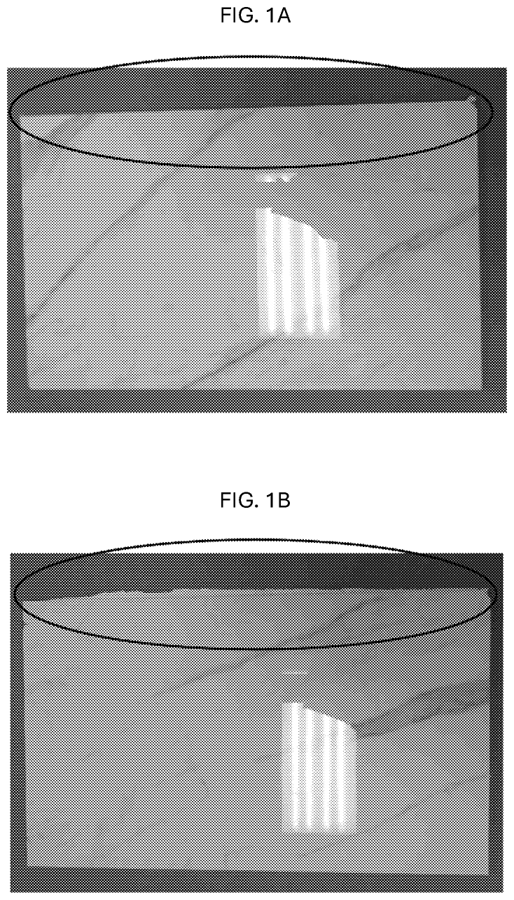

FIG. 1A is an example showing that a cut surface of the backer board in the cut body is substantially in line with a cut surface of the tile in the cut body. As shown in FIG. 1A (portion circled), when the cut surface of the backer board in the cut body is substantially in line with the cut surface of the tile in the cut body, the cut surface of the backer board is minimally observed with naked eyes at a distance of 2 ft. above the tile surface. On the other hand, FIG. 1B is an example showing that a cut surface of the backer board in the cut body is not substantially in line with a cut surface of the tile in the cut body. As shown in FIG. 1B (portion circled), when the cut surface of the backer board in the cut body is not substantially in line with the cut surface of the tile in the cut body, the cut surface of the backer board is visually observed with naked eyes at a distance of 2 ft. above the tile surface.

In one or more embodiments, the laminate body exhibits excellent adhesion between the cured resin composition and the backer board. For example, when evaluated using a polyethylene terephthalate (PET) substrate, the laminate body may exhibit a high PET material breakage rate. The PET material breakage rate may be in a range of from a lower limit selected from any one of 50%, 55%, 60%, and 65% to an upper limit selected from any one of 70%, 80%, 90%, 95%, and 100%. A higher PET material breakage rate indicates that failure occurs within the PET substrate rather than within the cured resin composition, for example, cohesive failure, thereby demonstrating strong adhesion.

That is, the present invention relates to the following: (1) a curable resin composition including 100 parts by weight of a moisture curable resin containing a reactive silyl group; 2 to 100 parts by weight of a thixotropic agent; and 5 to 20 parts by weight of an adhesion promoter, wherein a Brookfield viscosity of the curable resin composition is 10,000 cP or more and 1,000,000 cP or less at a temperature of 23 °C at 10 rpm.

(2) The curable resin composition according to (1), wherein a content of the thixotropic agent is 2 to 50 parts by weight.

(3) The curable resin composition according to any one of (1) to (2), wherein a cured resin composition of the curable resin composition has a tensile strength at break of 1.1 to 3.0 MPa.

(4) The curable resin composition according to any one of (1) to (3), wherein the moisture curable resin includes a polymer selected from the group consisting of a polyoxyalkylene-based polymer, a (meth)acrylic ester-based copolymer and combinations thereof.

(5) The curable resin composition according to any one of (1) to (4), wherein the moisture curable resin is the polyoxyalkylene-based polymer.

(6) The curable resin composition according to any one of (1) to (5), wherein the thixotropic agent is selected from the group consisting of a hydrogenated castor oil, an organic amid wax, an organic bentonite, a calcium stearate, a surface-treated calcium carbonate and combinations thereof.

(7) The curable resin composition according to any one of (1) to (6), wherein the Brookfield viscosity of the curable resin composition is 15,000 cP or more and 500,000 cP or less at a temperature of 23 °C at 10 rpm.

(8) The curable resin composition according to any one of (1) to (7), wherein the curable resin composition further comprises 20 to 200 parts by weight of a plasticizer.

(9) The curable resin composition according to any one of (1) to (8), wherein the adhesion promoter is an amino-group-containing silane.

(10) The curable resin composition according to any one of (1) to (9), wherein the curable resin composition is a one-component adhesive.

(11) A laminate body includes a tile; a backer board; and a cured resin composition of a curable resin composition disposed between the backer board and the tile, wherein the curable resin composition includes: 100 parts by weight of a moisture curable resin containing a reactive silyl group; 2 to 100 parts by weight of a thixotropic agent; and 5 to 20 parts by weight of an adhesion promoter, wherein a Brookfield viscosity of the curable resin composition is 10,000 cP or more and 1,000,000 cP or less at a temperature of 23 °C at 10 rpm.

(12) The laminate body according to (11), wherein a content of the thixotropic agent is 2 to 50 parts by weight.

(13) The laminate body according to any one of (11) to (12), wherein a cured resin composition of the curable resin composition has a tensile strength at break of 1.1 to 3.0 MPa.

(14) The laminate body according to any one of (11) to (13), wherein the moisture curable resin includes a polymer selected from the group consisting of a polyoxyalkylene-based polymer, a (meth)acrylic ester-based copolymer and combinations thereof.

(15) The laminate body according to any one of (11) to (14), wherein the moisture curable resin is the polyoxyalkylene-based polymer.

(16) The laminate body according to any one of (11) to (15), wherein the thixotropic agent is selected from the group consisting of a hydrogenated castor oil, an organic amid wax, an organic bentonite, a calcium stearate, a surface-treated calcium carbonate and combinations thereof.

(17) The laminate body according to any one of (11) to (16), wherein the Brookfield viscosity of the curable resin composition is 15,000 cP or more and 500,000 cP or less at a temperature of 23 °C at 10 rpm.

(18) The laminate body according to any one of (11) to (17), wherein the curable resin composition further comprises 20 to 200 parts by weight of a plasticizer.

(19) The laminate body according to any one of (11) to (18), wherein the adhesion promoter is an amino-group-containing silane.

(20) The laminate body according to any one of (11) to (19), wherein the backer board comprises a foam material.

(21) The laminate body according to any one of (11) to (20), wherein the curable resin composition is a one-component adhesive.

(22) A method includes cutting a laminate body including a tile, a backer board and a cured resin composition of a curable resin composition which is disposed between the tile and the backer board, to predetermined size, thereby forming a cut body; applying an adhesive to a surface of the cut body on a backer board side; bonding the cut body to a substrate, wherein the curable resin composition comprises: 100 parts by weight of a moisture curable resin containing a reactive silyl group; 2 to 100 parts by weight of a thixotropic agent; and 5 to 20 parts by weight of an adhesion promoter, wherein a Brookfield viscosity of the curable resin composition is 10,000 cP or more and 1,000,000 cP or less at a temperature of 23 °C at 10 rpm.

(23) The method according to (22), wherein a content of the thixotropic agent is 2 to 50 parts by weight.

(24) The method according to any one of (22) to (23), wherein a cut surface of the backer board in the cut body is substantially in line with a cut surface of the tile in the cut body.

(25) The method according to any one of (22) to (24), wherein the adhesive comprises the curable resin composition.

### EXAMPLES

The following examples are provided to illustrate embodiments of the present disclosure. The Examples are not intended to limit the scope of the present invention, and they should not be so interpreted.

The polyoxyalkylene-based polymers containing the reactive silyl group A-1, A-2, A-3, A-4, A-5, A-6, A-7, and A-8 were synthesized as follows. The number-average molecular weight Mn (polystyrene equivalent) was measured with the use of HLC-8120GPC (TOSOH CORPORATION) as a solution-sending system, TSK-GEL H type column (TOSOH CORPORATION), and THF solvent. The number of terminal silyl groups was determined by ¹H-NMR (JNM-LA400, CDCl3 solvent).

### A-1: The Polyoxyalkylene-Based Polymers Containing the Reactive Silyl Group

Propylene oxide was polymerized using polyoxypropylene triol having the number-average molecular weight of about 4,500 as an initiator in the presence of a zinc hexacyanocobaltate-glyme complex catalyst to obtain hydroxy-terminated polyoxypropylene having the number-average molecular weight of 16,400 (end group-equivalent molecular weight is 12,200) and a dispersity Mw/Mn of 1.31.

Sodium methoxide dissolved in methanol at a concentration of 28% was added in an amount of 1.2 molar equivalents per molar equivalent of the hydroxy groups of the resulting hydroxy-terminated polyoxypropylene. Methanol was distilled off by evaporation under vacuum, and then 1.5 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified allyl-terminated polyoxypropylene was mixed with n-hexane and water, and the mixture was stirred and then centrifuged to remove water. Hexane was evaporated under reduced pressure, and thus the metal salt was removed to obtain purified allyl-terminated polyoxypropylene.

To 500 g of the resulting purified allyl-terminated polyoxypropylene, 50 μl of platinum-divinyldisiloxane complex solution (isopropanol solution with a concentration of 3 wt % calculated as the platinum content), and 8.9 g of dimethoxymethylsilane were slowly added dropwise under stirring. The liquid mixture was reacted at 100 °C for 2 hours, and then unreacted dimethoxymethylsilane was distilled off under reduced pressure to obtain (A-1) polyoxypropylene having a dimethoxymethylsilyl group at the molecular termini. The resulting polymer (A-1) has the number-average molecular weight of 16,400, 0.7 dimethoxymethylsilyl group on average per end and 2.1 dimethoxymethylsilyl groups on average per molecule.

### A-2: The Polyoxyalkylene-Based Polymers Containing the Reactive Silyl Group

Propylene oxide was polymerized using polyoxypropylene glycol having the number-average molecular weight of about 4,500 as an initiator in the presence of a zinc hexacyanocobaltate-glyme complex catalyst to obtain hydroxy-terminated polyoxypropylene having the number-average molecular weight of 16,200 (end group-equivalent molecular weight is 10,200) and a dispersity Mw/Mn of 1.23.

Sodium methoxide dissolved in methanol at a concentration of 28% was added in an amount of 1.2 molar equivalents per molar equivalent of the hydroxy groups of the resulting hydroxy-terminated polyoxypropylene. Methanol was distilled off by evaporation under vacuum, and then 1.5 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified allyl-terminated polyoxypropylene was mixed with n-hexane and water, and the mixture was stirred and then centrifuged to remove water. Hexane was evaporated under reduced pressure, and thus the metal salt was removed to obtain purified allyl-terminated polyoxypropylene.

To 500 g of the resulting purified allyl-terminated polyoxypropylene, 50 μl of platinum-divinyldisiloxane complex solution (isopropanol solution with a concentration of 3 wt % calculated as the platinum content), and 6.5 g of dimethoxymethylsilane were slowly added dropwise under stirring. The liquid mixture was reacted at 100 °C for 2 hours, and then unreacted dimethoxymethylsilane was distilled off under reduced pressure to obtain (A-2) polyoxypropylene having a dimethoxymethylsilyl group at the molecular termini. The resulting polymer (A-2) has the number-average molecular weight of 16,400, 0.6 dimethoxymethylsilyl group on average per end and 1.2 dimethoxymethylsilyl groups on average per molecule.

### A-3: The Polyoxyalkylene-Based Polymers Containing the Reactive Silyl Group

Propylene oxide was polymerized using butanol as an initiator in the presence of a zinc hexacyanocobaltate-glyme complex catalyst to obtain polyoxypropylene having hydroxy groups at one end of the molecular termini and having the number-average molecular weight of 8,300 (end group-equivalent molecular weight is 5,500) and a dispersity Mw/Mn of 1.38.

Sodium methoxide dissolved in methanol at a concentration of 28% was added in an amount of 1.2 molar equivalents per molar equivalent of the hydroxy groups of the resulting hydroxy-terminated polyoxypropylene. Methanol was distilled off by evaporation under vacuum, and then 2.0 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified one end allyl-terminated polyoxypropylene was mixed with n-hexane and water, and the mixture was stirred and then centrifuged to remove water. Hexane was evaporated under reduced pressure, and thus the metal salt was removed to obtain purified polyoxypropylene having an allyl group at only one end of the molecular termini.

To 500 g of the resulting purified polyoxypropylene, 50 μl of platinum-divinyldisiloxane complex solution (2-propanol solution with a concentration of 3 wt % calculated as the platinum content), and 9.5 g of dimethoxymethylsilane were slowly added dropwise under stirring. The liquid mixture was reacted at 100 °C for 2 hours, and then unreacted dimethoxymethylsilane was distilled off under reduced pressure to obtain (A-3) polyoxypropylene having a dimethoxymethylsilyl group at only one end of the molecular termini. The resulting polymer (A-3) has the number-average molecular weight of 8,500 and 0.8 dimethoxymethylsilyl group on average per molecule.

### A-4: The Polyoxyalkylene-Based Polymers Containing the Reactive Silyl Group

To polyoxypropylene triol having the number-average molecular weight of about 4,500, sodium methoxide dissolved in methanol at a concentration of 28% was added in an amount of 1.2 molar equivalents per molar equivalent of the hydroxy groups of the polyoxypropylene triol. Methanol was distilled off by evaporation under vacuum, and then 1.5 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified allyl-terminated polyoxypropylene was mixed with n-hexane and water, and the mixture was stirred and then centrifuged to remove water. Hexane was evaporated under reduced pressure, and thus the metal salt was removed to obtain purified allyl-terminated polyoxypropylene.

To 500 g of the resulting purified allyl-terminated polyoxypropylene, 50 μl of platinum-divinyldisiloxane complex solution (isopropanol solution with a concentration of 3 wt % calculated as the platinum content), and 40.7 g of dimethoxymethylsilane were slowly added dropwise under stirring. The liquid mixture was reacted at 100 °C for 2 hours, and then unreacted dimethoxymethylsilane was distilled off under reduced pressure to obtain (A-4) polyoxypropylene having a dimethoxymethylsilyl group at the molecular termini. The resulting polymer (A-4) has the number-average molecular weight of 5,000, 0.7 dimethoxymethylsilyl group on average per end and 2.1 dimethoxymethylsilyl groups on average per molecule.

### A-5: The Polyoxyalkylene-Based Polymers Containing the Reactive Silyl Group

Propylene oxide was polymerized using polyoxypropylene glycol having the number-average molecular weight of about 4,500 as an initiator in the presence of a zinc hexacyanocobaltate-glyme complex catalyst to obtain hydroxy-terminated polyoxypropylene having the number-average molecular weight of 27,900 (end group-equivalent molecular weight is 17,700) and a dispersity Mw/Mn of 1.21.

Sodium methoxide dissolved in methanol at a concentration of 28% was added in an amount of 1.2 molar equivalents per molar equivalent of the hydroxy groups of the resulting hydroxy-terminated polyoxypropylene. Methanol was distilled off by evaporation under vacuum, and then 1.5 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified allyl-terminated polyoxypropylene was mixed with n-hexane and water, and the mixture was stirred and then centrifuged to remove water. Hexane was evaporated under reduced pressure, and thus the metal salt was removed to obtain purified allyl-terminated polyoxypropylene.

To 500 g of the resulting purified allyl-terminated polyoxypropylene, 50 μl of platinum-divinyldisiloxane complex solution (isopropanol solution with a concentration of 3 wt % calculated as the platinum content), and 4.8 g of dimethoxymethylsilane were slowly added dropwise under stirring. The liquid mixture was reacted at 100 °C for 2 hours, and then unreacted dimethoxymethylsilane was distilled off under reduced pressure to obtain (A-5) polyoxypropylene having a dimethoxymethylsilyl group at the molecular termini. The resulting polymer (A-5) has the number-average molecular weight of 28,500, 0.8 dimethoxymethylsilyl group on average per end and 1.6 dimethoxymethylsilyl groups on average per molecule.

### A-6: The Polyoxyalkylene-Based Polymers Containing the Reactive Silyl Group

Propylene oxide was polymerized using polyoxypropylene triol having the number-average molecular weight of about 4,500 as an initiator in the presence of a zinc hexacyanocobaltate-glyme complex catalyst to obtain hydroxy-terminated polyoxypropylene having the number-average molecular weight of 24,600 (end group-equivalent molecular weight is 17,400) and a dispersity Mw/Mn of 1.31.

Sodium methoxide dissolved in methanol at a concentration of 28% was added in an amount of 1.2 molar equivalents per molar equivalent of the hydroxy groups of the resulting hydroxy-terminated polyoxypropylene. Methanol was distilled off by evaporation under vacuum, and then 1.5 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified allyl-terminated polyoxypropylene was mixed with n-hexane and water, and the mixture was stirred and then centrifuged to remove water. Hexane was evaporated under reduced pressure, and thus the metal salt was removed to obtain purified allyl-terminated polyoxypropylene.

To 500 g of the resulting purified allyl-terminated polyoxypropylene, 50 μl of platinum-divinyldisiloxane complex solution (isopropanol solution with a concentration of 3 wt % calculated as the platinum content), and 6.4 g of dimethoxymethylsilane were slowly added dropwise under stirring. The liquid mixture was reacted at 100 °C for 2 hours, and then unreacted dimethoxymethylsilane was distilled off under reduced pressure to obtain (A-6) polyoxypropylene having a dimethoxymethylsilyl group at the molecular termini. The resulting polymer (A-6) has the number-average molecular weight of 26,200, 0.7 dimethoxymethylsilyl group on average per end and 2.2 dimethoxymethylsilyl groups on average per molecule.

### A-7: The Polyoxyalkylene-Based Polymers Containing the Reactive Silyl Group

To polyoxypropylene glycol having the number-average molecular weight of about 4,500, sodium methoxide dissolved in methanol at a concentration of 28% was added in an amount of 1.2 molar equivalents per molar equivalent of the hydroxy groups of the polyoxypropylene glycol. Methanol was distilled off by evaporation under vacuum, and then 1.5 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified allyl-terminated polyoxypropylene was mixed with n-hexane and water, and the mixture was stirred and then centrifuged to remove water. Hexane was evaporated under reduced pressure, and thus the metal salt was removed to obtain purified allyl-terminated polyoxypropylene.

To 500 g of the resulting purified allyl-terminated polyoxypropylene, 50 μl of platinum-divinyldisiloxane complex solution (isopropanol solution with a concentration of 3 wt % calculated as the platinum content), and 30 g of dimethoxymethylsilane were slowly added dropwise under stirring. The liquid mixture was reacted at 100 °C for 2 hours, and then unreacted dimethoxymethylsilane was distilled off under reduced pressure to obtain (A-7) polyoxypropylene having a dimethoxymethylsilyl group at the molecular termini. The resulting polymer (A-7) has the number-average molecular weight of 5,000, 0.7 dimethoxymethylsilyl group on average per end and 1.4 dimethoxymethylsilyl groups on average per molecule.

### A-8: The Polyoxyalkylene-Based Polymers Containing the Reactive Silyl Group

Propylene oxide was polymerized using polyoxypropylene triol having the number-average molecular weight of about 4,500 as an initiator in the presence of a zinc hexacyanocobaltate-glyme complex catalyst to obtain hydroxy-terminated polyoxypropylene having the number-average molecular weight of 14,300 (end group-equivalent molecular weight is 9,100) and a dispersity Mw/Mn of 1.21.

Sodium methoxide dissolved in methanol at a concentration of 28% was added in an amount of 1.2 molar equivalents per molar equivalent of the hydroxy groups of the resulting hydroxy-terminated polyoxypropylene. Methanol was distilled off by evaporation under vacuum, and then 1.5 molar equivalents of allyl chloride was added per molar equivalent of the hydroxy groups of the polymer to convert the terminal hydroxy groups to allyl groups. Unreacted allyl chloride was removed by evaporation under reduced pressure. The resulting unpurified allyl-terminated polyoxypropylene was mixed with n-hexane and water, and the mixture was stirred and then centrifuged to remove water. Hexane was evaporated under reduced pressure, and thus the metal salt was removed to obtain purified allyl-terminated polyoxypropylene.

To 500 g of the resulting purified allyl-terminated polyoxypropylene, 50 μl of platinum-divinyldisiloxane complex solution (isopropanol solution with a concentration of 3 wt % calculated as the platinum content), and 8.4 g of dimethoxymethylsilane were slowly added dropwise under stirring. The liquid mixture was reacted at 100 °C for 2 hours, and then unreacted dimethoxymethylsilane was distilled off under reduced pressure to obtain (A-8) polyoxypropylene having a dimethoxymethylsilyl group at the molecular termini. The resulting polymer (A-8) has the number-average molecular weight of 14,600, 0.8 dimethoxymethylsilyl group on average per end and 1.5 dimethoxymethylsilyl groups on average per molecule.

The silica sand, Sand 40-140 is available from Standard Sand & Silica, Co. The plasticizer, DPHP is available from BASF, Exxol D80 is available from ExxonMobil and PPG3000 is available from Mitsui Chemicals, Inc. The CaCO₃ filler, Hubercarb G8 is available from Huber Engineered Materials. The balloon fillers, EMC-80 is available from Japan Fillite. Thixotropic agents, Crayvallac SLT is available from Arkema, Viscoexcel-30 is available from Shiraishi, and Hakuenka CC-R is available from Shiraishi. The adhesion promoter, DAMO-T is available from Evonik. The organotin catalyst, NEOSTANN U-220H is available from Nitto Kasi Co., Ltd. Other additives, VTMO is available from Evonik, Ti-Pure R⁹⁰²+ is available from Chemours, and Tinuvin 328, Tinuvin 770 and Irganox 245 are available from BASF.

Curable resin compositions Examples 1-18 (Ex. 1-18) and Comparative Examples 1-5 (Comp. Ex. 1-5) were produced by mixing moisture curable resin(s) (A-1 to A-8), thixotropic agent(s), adhesion promoter(s), and various additives as shown in Tables 1-1, 1-2, 1-3, 1-4, and 1-5.

TABLE 1-1

| | | | Ex. 1 | Ex. 2 | Ex. 3 | Ex. 4 | Ex. 5 |
|---|---|---|---|---|---|---|---|
| Formulation | (A)polyoxyalkylene | (A-1) | 100 | 50 | 30 | | |
| | polymer | (A-2) | | | | | 100 |
| | | (A-3) | | | | | |
| | | (A-4) | | 50 | 70 | 100 | |
| | | (A-5) | | | | | |
| | | (A-6) | | | | | |
| | Plasticizer | DPHP | | | | | |
| | | Exxol D80 | 40 | 40 | 40 | 40 | 40 |
| | | PPG3000 | 100 | 100 | 100 | 100 | 100 |
| | Calcium carbonate | G8 | 500 | 500 | 500 | 500 | 450 |
| | (B)Thixotropic agent | Viscoexcel-30 | 18 | 18 | | 18 | 18 |
| | | Crayvallac SLT | | | 3 | | |
| | Plastic balloon | EMC-80 | 15 | 15 | 15 | 15 | 15 |
| | Silica sand | Sand 40-140 | 60 | 60 | 60 | 60 | 60 |
| | Titanium oxide | Ti-Pure R902+ | 10 | 10 | 10 | 10 | 10 |
| | UVA | Tinuvin 328 | 1 | 1 | 1 | 1 | 1 |
| | HALS | Tinuvin 770 | 1 | 1 | 1 | 1 | 1 |
| | AO | Irganox245 | 1 | 1 | 1 | 1 | 1 |
| | Silanes | VTMO | 3 | 3 | 3 | 3 | 3 |
| | (C)Adhesion promoter | DAMO-T | 8 | 8 | 8 | 8 | 8 |
| | Catalyst | U-220H | 2 | 2 | 2 | 2 | 2 |

| | | | | | |
|---|---|---|---|---|---|
| Total | 859.0 | 859.0 | 844.0 | 859.0 | 809.0 |

TABLE 1-2

| | | | Ex. 6 | Ex. 7 | Ex. 8 | Ex. 9 | Ex. 10 |
|---|---|---|---|---|---|---|---|
| Formulation | (A)polyoxyalkylene | (A-1) | 50 | 100 | 100 | | |
| | polymer | (A-2) | | | | | |
| | | (A-3) | 50 | | | | |
| | | (A-4) | | | | | |
| | | (A-5) | | | | 100 | |
| | | (A-6) | | | | | 100 |
| | Plasticizer | DPHP | 120 | | | | |
| | | Exxol D80 | | 60 | 20 | 40 | 40 |
| | | PPG3000 | | 110 | 80 | 100 | 100 |
| | Calcium carbonate | G8 | 500 | 500 | 200 | 500 | 500 |
| | (B)Thixotropic agent | Viscoexcel-30 | 18 | 18 | 18 | 18 | 18 |
| | | Crayvallac SLT | | | | | |
| | Plastic balloon | EMC-80 | 15 | 50 | | 15 | 15 |
| | Silica sand | Sand 40-140 | 60 | 60 | | 60 | 60 |
| | Titanium oxide | Ti-Pure R902+ | 10 | 10 | 10 | 10 | 10 |
| | UVA | Tinuvin 328 | 1 | 1 | 1 | 1 | 1 |
| | HALS | Tinuvin 770 | 1 | 1 | 1 | 1 | 1 |
| | AO | Irganox245 | 1 | 1 | 1 | 1 | 1 |
| | Silanes | VTMO | 3 | 3 | 3 | 3 | 3 |
| | (C)Adhesion promoter | DAMO-T | 8 | 8 | 8 | 8 | 8 |
| | Catalyst | U-220H | 2 | 2 | 2 | 2 | 2 |

| | | | | | |
|---|---|---|---|---|---|
| Total | 839.0 | 924.0 | 444.0 | 859.0 | 859.0 |

TABLE 1-3

| | | | Comp. | Comp. | Comp. | Comp. |
|---|---|---|---|---|---|---|
| | | | Ex. 1 | Ex. 2 | Ex. 3 | Ex. 4 |
| Formulation | (A)polyoxyalkylene | (A-1) | | 100 | 100 | 100 |
| | polymer | (A-2) | | | | |
| | | (A-3) | | | | |
| | | (A-4) | 100 | | | |
| | | (A-5) | | | | |
| | | (A-6) | | | | |
| | Plasticizer | DPHP | | | | |
| | | Exxol D80 | 40 | 40 | 40 | 5 |
| | | PPG3000 | 100 | 100 | 100 | 10 |
| | Calcium carbonate | G8 | 500 | 500 | 500 | 500 |
| | (B)Thixotropic agent | Viscoexcel-30 | | | 18 | 18 |
| | | Crayvallac SLT | | | | |
| | Plastic balloon | EMC-80 | 15 | 15 | 15 | 15 |
| | Silica sand | Sand 40-140 | 60 | 60 | 60 | 60 |
| | Titanium oxide | Ti-Pure R902+ | 10 | 10 | 10 | 10 |
| | UVA | Tinuvin 328 | 1 | 1 | 1 | 1 |
| | HALS | Tinuvin 770 | 1 | 1 | 1 | 1 |
| | AO | Irganox245 | 1 | 1 | 1 | 1 |
| | Silanes | VTMO | 3 | 3 | 3 | 3 |
| | (C)Adhesion promoter | DAMO-T | 4 | 8 | 4 | 8 |
| | Catalyst | U-220H | 2 | 2 | 2 | 2 |

| | | | | |
|---|---|---|---|---|
| Total | 837.0 | 841.0 | 855.0 | 734.0 |

TABLE 1-4

| | | | Ex. 11 | Ex. 12 | Ex. 13 | Ex. 14 | Ex. 15 |
|---|---|---|---|---|---|---|---|
| Formulation | (A)polyoxyalkylene | (A-1) | 65 | 100 | | | |
| | polymer | (A-5) | | | | | 100 |
| | | (A-7) | 45 | | | | |
| | | (A-8) | | | 100 | 100 | |
| | Plasticizer | Exxol D80 | 85 | | 60 | 20 | 60 |
| | | PPG3000 | | 100 | 110 | 100 | 110 |
| | Calcium carbonate | MarbleWhite 325 | 350 | 300 | 350 | 300 | 350 |
| | (B)Thixotropic agent | CC-R | 50 | 50 | 50 | 50 | 50 |
| | Plastic balloon | EMC-80 | 20 | 15 | 30 | 20 | 30 |
| | Titanium oxide | Ti-Pure R902+ | 10 | 10 | 10 | 10 | 10 |
| | UVA | Tinuvin 328 | 1 | 1 | 1 | 1 | 1 |
| | HALS | Tinuvin 770 | 1 | 1 | 1 | 1 | 1 |
| | AO | Irganox245 | 1 | 1 | 1 | 1 | 1 |
| | Silanes | VTMO | 15 | 15 | 15 | 15 | 15 |
| | (C)Adhesion promoter | DAMO-T | 8 | 8 | 8 | 8 | 8 |
| | Catalyst | U-220H | 2 | 2 | 2 | 2 | 2 |

| | | | | | |
|---|---|---|---|---|---|
| Total | 653.0 | 603.0 | 738.0 | 628.0 | 738.0 |

TABLE 1-5

| | | | | | | Comp. |
|---|---|---|---|---|---|---|
| | | | Ex. 16 | Ex. 17 | Ex. 18 | Ex. 5 |
| Formulation | (A)polyoxyalkylene | (A-1) | 100 | 100 | 100 | 100 |
| | polymer | (A-5) | | | | |
| | | (A-7) | | | | |
| | | (A-8) | | | | |
| | Plasticizer | Exxol D80 | 70 | 20 | 70 | 60 |
| | | PPG3000 | 110 | 50 | | 110 |
| | Calcium carbonate | MarbleWhite 325 | 350 | 100 | 350 | 350 |
| | (B)Thixotropic agent | CC-R | 25 | 50 | 50 | |
| | Plastic balloon | EMC-80 | 30 | 5 | 5 | 30 |
| | Titanium oxide | Ti-Pure R902+ | 10 | 10 | 10 | 10 |
| | UVA | Tinuvin 328 | 1 | 1 | 1 | 1 |
| | HALS | Tinuvin 770 | 1 | 1 | 1 | 1 |
| | AO | Irganox245 | 1 | 1 | 1 | 1 |
| | Silanes | VTMO | 15 | 15 | 15 | 15 |
| | (C)Adhesion promoter | DAMO-T | 8 | 8 | 8 | 8 |
| | Catalyst | U-220H | 2 | 2 | 2 | 2 |

| | | | | |
|---|---|---|---|---|
| Total | 723.0 | 363.0 | 613.0 | 688.0 |

Various physical properties of the curable resin compositions of Examples 1-18 and Comparative Examples 1-5 were measured as described below.

Dynamic viscosities of the curable resin compositions were measured by a Brookfield rotational viscometer (“RV” or “Brookfield” viscosity) at a temperature of 23 °C with an RV-06 spindle. 250 ml of each curable resin composition was used to measure the viscosity. The viscosity was measured at a frequency of 1 rpm, 2 rpm, and 10 rpm. The Brookfield Thixotropic Index value of each curable resin composition was determined by dividing the RV viscosity at 2 rpm by the RV viscosity of the same resin composition at 10 rpm.

The cured test samples having a thickness of 3 mm were cut into dimensions per ASTM D412 and a tensile test was conducted using a Universal tensile testing machine. The test was conducted in accordance with ASTM D412 to obtain a tensile strength at break.

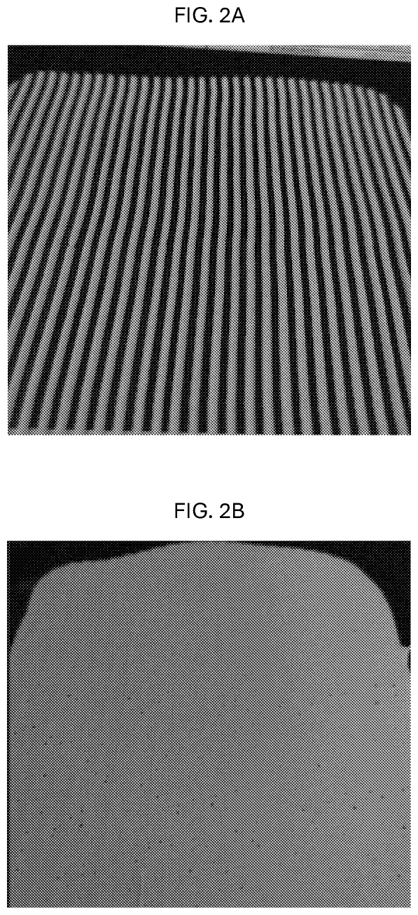

Workability (comb trowel workability and shape retention) was tested with 1/16 in.× 1/16 in.× 1/16 in. comb trowel. The appropriate amount of the curable resin compositions was each placed on an evaluation plate, smoothed with a spatula, and then applied with the comb trowel at an angle of 60 degrees. The curable resin compositions of Examples 1-18 and Comparative Examples 1-3 and 5 show good applicability satisfying the comb trowel workability. The shape retention properties of the curable resin compositions (Examples 1-18 and Comparative Examples 1-3 and 5) were measured after the curable resin compositions were applied with the comb trowel to the evaluation plate and aged at 23 °C for 5 minutes. The curable resin compositions satisfying the shape retention test maintain the mountain shape of the curable resin compositions. FIG. 2A is an example showing that a curable resin composition satisfies the shape retention test. FIG. 2B is an example showing that a curable resin composition does not satisfy the shape retention test.

The resin compositions were applied to a polyethylene terephthalate (PET) sheet and aged at 23 °C for 7 days. Thereafter, the cured resin compositions were subjected to a 90-degree hand peel test and the adhesion properties were investigated. A rating “excellent” was given when the material was not peeled off from the PET sheet and the material remained on the sheet. A rating “good” was given when the material was peeled off from PET sheet, but a thin layer of the material remained on the sheet. A rating “poor” was given when the material peeled from PET sheet and the material did not remain on the sheet.

Each laminate body (Examples 1-18 and Comparative Examples 1-4) was prepared with the present curable resin compositions, a porcelain tile (2 in.×2 in.×6 mm, available from MAXIMO) and a PET foam board (2 in.×2 in.×10 mm, available from McMASTER-CARR).

The curable resin compositions were applied to a tile with 1/16 in.× 1/16 in.× 1/16 in. comb trowel. The foam board was bonded thereto to form the laminate body and the laminate body was pressed with a 4.5 lb. dumbbell for 30 seconds from the foam board side. The laminate body was then aged at 23 °C for 24 hours.

To measure the backer board crack conformity of each laminate body, a cut was made on the surface of the tile on the laminate body by a tile cutter, the laminate body was divided with hand along with the cut and then the cut surface was observed.

A rating “excellent” was given when the cut surface of the foam board was minimally observed with naked eyes at a distance of 2 ft. above the tile surface. A rating “poor” was given when the cut surface of the foam board was visually observed with naked eyes at a distance of 2 ft. above the tile surface. The laminate body rated “excellent” had a cut surface such that a cut surface of the backer board was substantially in line with a cut surface of the tile. As described above, FIG. 1A is an example showing an excellent cut surface and FIG. 1B is an example showing a poor cut surface.

To evaluate the PET material breakage rate, a laminate body was prepared using a porcelain tile (4 in.×4 in.×8 mm, cut down in this specific size from a larger tile available from Maximo) and a PET foam board (6 in.×6 in.×0.5 in., available from McMASTER-CARR). The curable resin composition was applied to the tile and the PET foam board was bonded thereto. The laminate body was aged at 23 °C for one week and the PET foam board was then manually peeled from the tile. The adhesion was evaluated based on the area of PET foam remaining on the tile surface. A result was considered to be acceptable when 50% or more of the PET foam remained on the tile surface after peeling.

TABLE 2-1

| | | | Ex. 1 | Ex. 2 | Ex. 3 | Ex. 4 | Ex. 5 |
|---|---|---|---|---|---|---|---|
| viscosity | 1 rpm | cp | 211,000 | 147,000 | 378,000 | 124,000 | 242,000 |
| | 2 rpm | cp | 130,500 | 89,000 | 218,500 | 71,000 | 147,000 |
| | 10 rpm | cp | 54,700 | 33,900 | 74,900 | 24,300 | 58,500 |

| | | | | | | |
|---|---|---|---|---|---|---|
| | ([2 rpm]/[10 rpm]) | 2.39 | 2.63 | 2.92 | 2.92 | 2.51 |
| Results | Comb trowel workability | ∘ | ∘ | ∘ | ∘ | ∘ |
| | Hand Peel - PET | Excellent | Excellent | Excellent | Excellent | Excellent |
| | Shape retention | Excellent | Excellent | Excellent | Excellent | Excellent |
| | Backer board crack conformity | Excellent | Excellent | Excellent | Excellent | Excellent |

TABLE 2-2

| | | | Ex. 6 | Ex. 7 | Ex. 8 | Ex. 9 | Ex. 10 |
|---|---|---|---|---|---|---|---|
| viscosity | 1 rpm | cp | 341,000 | 325,000 | 354,000 | 376,000 | 904,000 |
| | 2 rpm | cp | 206,500 | 203,000 | 209,000 | 237,500 | 580,000 |
| | 10 rpm | cp | 82,200 | 91,600 | 78,000 | 114,800 | 268,000 |

| | | | | | | |
|---|---|---|---|---|---|---|
| | ([2 rpm]/[10 rpm]) | 2.51 | 2.22 | 2.68 | 2.07 | 2.16 |
| Results | Comb trowel workability | ∘ | ∘ | ∘ | ∘ | ∘ |
| | Hand Peel - PET | Excellent | Excellent | Excellent | Excellent | Excellent |
| | Shape retention | Excellent | Excellent | Excellent | Excellent | Excellent |
| | Backer board crack conformity | Excellent | Excellent | Excellent | Excellent | Excellent |

TABLE 2-3

| | | | Comp. | Comp. | Comp. | Comp. |
|---|---|---|---|---|---|---|
| | | | Ex. 1 | Ex. 2 | Ex. 3 | Ex. 4 |
| viscosity | 1 rpm | cp | 24,000 | 30,000 | 201,000 | 7,632,000 |
| | 2 rpm | cp | 17,500 | 27,500 | 120,500 | 4,688,000 |
| | 10 rpm | cp | 9,900 | 23,200 | 53,200 | 2,045,000 |

| | | | | | |
|---|---|---|---|---|---|
| | ([2 rpm]/[10 rpm]) | 1.77 | 1.19 | 2.27 | 2.29 |
| Results | Comb trowel workability | ∘ | ∘ | ∘ | x |
| | Hand Peel - PET | Poor | Good | Poor | Good |
| | Shape retention | Poor | Poor | Good | Not rated |
| | Backer board crack conformity | Poor | Poor | Poor | Not rated |

TABLE 2-4

| | | | Ex. 11 | Ex. 12 | Ex. 13 | Ex. 14 | Ex. 15 |
|---|---|---|---|---|---|---|---|
| Viscosity | 1 rpm | cp | 203,000 | 648,000 | 201,000 | 337,000 | 266,000 |
| | 2 rpm | cp | 111,000 | 380,000 | 118,500 | 204,500 | 165,000 |
| | 10 rpm | cp | 31,600 | 130,000 | 41,300 | 74,300 | 66,100 |

| | | | | | |
|---|---|---|---|---|---|
| ([2 rpm]/[10 rpm]) | 3.51 | 2.92 | 2.87 | 2.75 | 2.50 |

| | | | | | | |
|---|---|---|---|---|---|---|
| Tensile breaking strength | MPa | 2.14 | 1.31 | 0.90 | 1.00 | 0.86 |

| | | | | | | |
|---|---|---|---|---|---|---|
| Result | Comb trowel workability | ∘ | ∘ | ∘ | ∘ | ∘ |
| | Hand Peel - PET | Excellent | Excellent | Excellent | Excellent | Excellent |
| | Shape retention | Excellent | Excellent | Excellent | Excellent | Excellent |
| | Backer board crack conformity | Excellent | Excellent | Excellent | Excellent | Excellent |
| | PET material breakage rate | 95% | 70% | 0% | 30% | 0% |

TABLE 2-5

| | | | | | | Comp. |
|---|---|---|---|---|---|---|
| | | | Ex. 16 | Ex. 17 | Ex. 18 | Ex. 5 |
| Viscosity | 1 rpm | cp | 59,000 | 193,000 | 233,000 | 12,000 |
| | 2 rpm | cp | 36,500 | 110,000 | 131,000 | 11,000 |
| | 10 rpm | cp | 14,400 | 35,400 | 37,800 | 8,200 |

| | | | | |
|---|---|---|---|---|
| ([2 rpm]/[10 rpm]) | 2.53 | 3.11 | 3.47 | 1.34 |

| | | | | | |
|---|---|---|---|---|---|
| Tensile breaking strength | MPa | 0.88 | 1.32 | 2.89 | 1.01 |

| | | | | | |
|---|---|---|---|---|---|
| Result | Comb trowel workability | ∘ | ∘ | ∘ | ∘ |
| | Hand Peel - PET | Excellent | Excellent | Excellent | Excellent |
| | Shape retention | Excellent | Excellent | Excellent | Poor |
| | Backer board crack conformity | Excellent | Excellent | Excellent | Poor |
| | PET material breakage rate | 0% | 95% | 95% | 0% |

Examples 1-18 of the curable resin compositions display the effects of adding certain amounts of the thixotropic agent and the adhesion promoter to the polyoxyalkylene-based polymer containing the reactive silyl group, resulting in superior properties versus Comparative Examples 1-5. Comparative example 1 including only 4 parts by weight of DAMO-T and no thixotropic agent, Comparative example 2 including 8 parts by weight of DAMO-T, but not including the thixotropic agent, Comparative example 3 including the thixotropic agent, but only including 4 parts by weight of DAMO-T, Comparative example 4 including the thixotropic agent and 8 parts by weight of DAMO-T, but not including enough plasticizer, Comparative example 5 including 8 parts by weight of DAMO-T, but not including the thixotropic agent, do not show the required properties such as backer board crack conformity. Further, compositions not including the thixotropic agent or including an excessive amount of plasticizer exhibit a reduced PET material breakage rate.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112 (f) for any limitations of any of the claims herein, except for those in which the claim expressly uses the words ‘means for’ together with an associated function.

What is claimed is:

1. A curable resin composition, comprising:
100 parts by weight of a moisture curable resin containing a reactive silyl group;
2 to 100 parts by weight of a thixotropic agent; and
5 to 20 parts by weight of an adhesion promoter, wherein a Brookfield viscosity of the curable resin composition is 10,000 cP or more and 1,000,000 cP or less at a temperature of 23 °C at 10 rpm.

2. The curable resin composition of claim 1, wherein a content of the thixotropic agent is 2 to 50 parts by weight.

3. The curable resin composition of claim 1, wherein a cured resin composition of the curable resin composition has a tensile strength at break of 1.1 to 3.0 MPa.

4. The curable resin composition of claim 1, wherein the moisture curable resin is a polyoxyalkylene-based polymer.

5. The curable resin composition of claim 1, wherein the thixotropic agent is selected from the group consisting of a hydrogenated castor oil, an organic amid wax, an organic bentonite, a calcium stearate, a surface-treated calcium carbonate and combinations thereof.

6. The curable resin composition of claim 1, wherein the curable resin composition further comprises 20 to 200 parts by weight of a plasticizer.

7. The curable resin composition of claim 1, wherein the adhesion promoter is an amino-group-containing silane.

8. A laminate body comprises:
a tile;
a backer board; and
a cured resin composition of a curable resin composition disposed between the backer board and the tile, wherein the curable resin composition comprises:
100 parts by weight of a moisture curable resin containing a reactive silyl group;
2 to 100 parts by weight of a thixotropic agent; and
5 to 20 parts by weight of an adhesion promoter, wherein a Brookfield viscosity of the curable resin composition is 10,000 cP or more and 1,000,000 cP or less at a temperature of 23 °C at 10 rpm.

9. The laminate body of claim 8, wherein a content of the thixotropic agent is 2 to 50 parts by weight.

10. The laminate body of claim 8, wherein the cured resin composition has a tensile strength at break of 1.1 to 3.0 MPa.

11. The laminate body of claim 8, wherein the moisture curable resin is a polyoxyalkylene-based polymer.

12. The laminate body of claim 8, wherein the thixotropic agent is selected from the group consisting of a hydrogenated castor oil, an organic amid wax, an organic bentonite, a calcium stearate, a surface-treated calcium carbonate and combinations thereof.

13. The laminate body of claim 8, wherein the curable resin composition further comprises 20 to 200 parts by weight of a plasticizer.

14. The laminate body of claim 8, wherein the adhesion promoter is an amino-group-containing silane.

15. The laminate body of claim 8, wherein the backer board comprises a foam material.

16. A method comprising:
cutting a laminate body comprising a tile, a backer board and a cured resin composition of a curable resin composition which is disposed between the tile and the backer board, to predetermined size, thereby forming a cut body;
applying an adhesive to a surface of the cut body on a backer board side;
bonding the cut body to a substrate, wherein the curable resin composition comprises:
100 parts by weight of a moisture curable resin containing a reactive silyl group;
2 to 100 parts by weight of a thixotropic agent; and
5 to 20 parts by weight of an adhesion promoter, wherein a Brookfield viscosity of the curable resin composition is 10,000 cP or more and 1,000,000 cP or less at a temperature of 23 °C at 10 rpm.

17. The method of claim 16, wherein a content of the thixotropic agent is 2 to 50 parts by weight.

18. The method of claim 16, wherein a cut surface of the backer board in the cut body is substantially in line with a cut surface of the tile in the cut body.
